(19) United States
(12) Patent Application Publication
(10) Pub. No.: US 2007/0242467 A1
(43) Pub. Date: Oct. 18, 2007

(54) Stone craft product and method for manufacturing the stone craft product

(75) Inventor: Yu Zheng, Shenzhen (CN)

Correspondence Address: HAMRE, SCHUMANN, MUELLER & LARSON, P.C., P.O. BOX 2902, MINNEAPOLIS, MN, 55402-0902, US

(73) Assignee: CARDINY STONE (SHENZHEN) CO., LTD., Shenzhen (CN)

(21) Appl. No.: 11/484,479

(22) Filed: Jul. 11, 2006

(30) Foreign Application Priority Data
Mar. 29, 2006 (CN) 200610060103.2

(51) Int. Cl. F21V 3/04; F21V 3/02; B29C 65/00; B31B 1/62

(52) U.S. Cl. 362/363; 156/60

(57) ABSTRACT

A stone craft product and a method for manufacturing the stone craft product. The stone craft product includes a hollow mainbody, the hollow mainbody includes a plurality of light-transmitting stone pieces, the plurality of light-transmitting stone pieces is adhibited to each other; and a light source is accommodated in the hollow mainbody. The method for manufacturing a stone craft product includes steps of: cutting light-transmitting stone materials into a plurality of stone pieces; adhibiting the plurality of stone pieces to be a hollow mainbody by using an adhesive; and putting a light source into the hollow mainbody after the hollow mainbody becomes concreted. The method in accordance with the present invention is simplified, convenient and save stone materials, and the stone craft product manufactured by the method has enhanced aesthetic value and practicality.

### BACKGROUND OF THE INVENTION

1. Field of the Invention

The present invention relates to a field of craft product, and more especially to a stone craft product and method for manufacturing the stone craft product.

2. Background of the Invention

A decorative stone has function of decoration and can be used for architectural decoration. With the development of architecture conformation and styles, decorative stones are used more and more widely.

Making use of the decorative stones such as a bowlder or a marble, aesthetic and practical craft products can be achieved.

For example, there is a stone craft product, which is manufactured through hollowing out a spherally shaped light-transmitting stone and accomodating a light source therein. The spheral stone is illuminated from the inner side and it looks like a spheral decorative light. The art of hollowing out a stone is a complicated technology having high quality requirements of turnery and burnishing technology, which is time-consuming and high-cost. Furthermore, the art requires a whole solid stone block, which increases the difficulty of choosing materials, and the materials will be high-cost.

### BRIEF SUMMARY OF THE INVENTION

A primary object of the present invention is to provide a stone craft product and a method for manufacturing the stone craft product, the stone craft has enhanced aesthetic value and practicality.

The stone craft product in accordance with the present invention comprises a mainbody, the mainbody comprises a plurality of light-transmitting stone pieces, and a light source is accommodated in the mainbody. The plurality of light-transmitting stone pieces is adjacent to each other with a resin adhesive or a AB adhesive. The light source is various lighting device such as, for example, an electric light or a candle. The stone craft is able to be used for ornament and as an illuminator, which has enhanced aesthetic value and practicality.

To achieve the above-mentioned object, a method for manufacturing a stone craft product comprises steps of: cutting light-transmitting stone into a plurality of stone pieces by the ultrasonic technology or water jet technology; adhering the plurality of stone pieces to be a hollow mainbody by using adhesive; accommodating a light source into the mainbody after the mainbody becomes concreted. The method for manufacturing a stone craft product in accordance with the present invention is simplified, convenient and save stone materials.

Other objects, advantages and novel features of the present invention will become more apparent from the following detailed description when taken in conjunction with the accompanying drawings, in which:

### BRIEF DESCRIPTION OF THE DRAWINGS

FIG. 1 is a schematic view showing a stone craft product in accordance with the preferred embodiment of the present invention, which includes a mainbody;

FIG. 2 is an isometric view of the mainbody of FIG. 1, which includes a plurality of light-transmitting stone pieces; and

FIG. 3 is an cross-section view of FIG. 1, showing a light source accommodated in the mainbody.

### DETAILED DESCRIPTION OF THE INVENTION

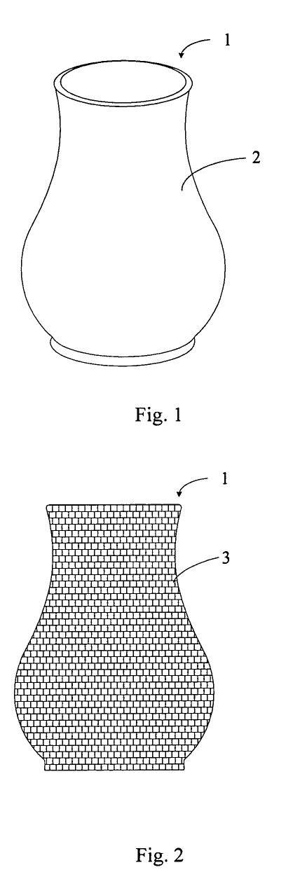

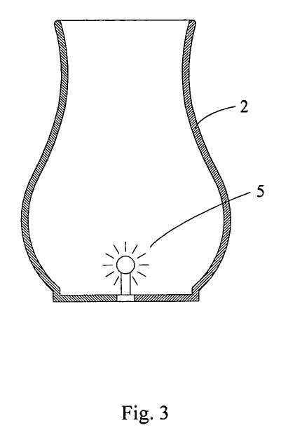

Referring to FIG. 1-3, a stone craft product 1 in accordance with the preferred embodiment of the present invention comprises a mainbody 2, the mainbody 2 comprises a plurality of light-transmitting stone pieces 3, and a light source 5 is accommodated in the mainbody 2. The plurality of light-transmitting stone pieces 3 is adjacent to each other. The light source often is various lighting device such as, for example, an electric and a candle. The plurality of light-transmitting stone pieces 3 is adhered to each other by an adhesive, such as, a resin adhesive or a AB adhesive. In this embodiment, the edges of the plurality of light-transmitting stone piece 3 are substantially adhibited to each other, as shown in FIG. 2. In another embodiment, the edges of the plurality of light-transmitting stone pieces 3 are partly adhibited to each other so that the mainbody 2 has a plurality of holes. When the light source 5 is illuminated, the light beams traverse through the mainbody 2, and the stone craft product 1 looks like a lightening jar.

A method for manufacturing a stone craft product in accordance with a preferred embodiment of the present invention includes steps as follows:

At the step 1, cutting a light-transmitting stone into a plurality of stone pieces by the ultrasonic technology, water jet technology, or conventional disc cutter. The light-transmitting stone is selected from various stone materials which have the feature of being transparent or translucent such as, for example, an onyx, a crystal stone, and so on.

Then turn to the step 2, adhibiting the plurality of stone pieces to be a hollow mainbody by using an adhesive. The adhesive is selected from a resin adhesive or a AB adhesive. The plurality of light-transmitting stone pieces is completely or partly adhibited to each other.

At the step 3, accommodating a light source into the hollow mainbody after the hollow mainbody becomes concreted. The light source often is various lightening device such as, for example, an electric light and a candle. The light is often placed on the bottom of the hollow mainbody.

The method for manufacturing a stone craft product in accordance with the present invention is simplified, convenient and save stone materials. The stone craft product in accordance with the present invention is used as an ornament or an illuminator, which has enhanced aesthetic value and practicality.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a stone craft product comprising steps of:
cutting light-transmitting stone materials into a plurality of stone pieces;
adhibiting the plurality of stone pieces to be a hollow mainbody by using an adhesive; and
accommodating a light source into the hollow mainbody after the hollow mainbody becomes concreted.

2. The method as claimed in claim 1, wherein the plurality of stone pieces is adhibited by the adhesive which can adhibit stone materials.

3. The method as claimed in claim 1, wherein the light source is a lighting device such as, an electric light or a candle, which is often placed on the bottom of the hollow mainbody.

4. A stone craft product, the stone craft product comprising:
a hollow mainbody, the hollow mainbody comprising a plurality of light-transmitting stone pieces, the plurality of light-transmitting stone pieces adhibited to each other; and
a light source accommodated in the hollow mainbody.

5. The stone craft product as claimed in claim 4, wherein the plurality of light-transmitting stone pieces is achieved through cutting light-transmitting stone materials.

6. The stone craft product as claimed in claim 5, wherein the plurality of light-transmitting stone pieces is adhibited to each other by the adhesive that can adhibit stone materials.

7. The stone craft product as claimed in claim 4, wherein the light source is a lighting device such as, an electric light or a candle, which is often placed on the bottom of the hollow mainbody.
